(19) United States
(12) Patent Application Publication
(10) Pub. No.: US 2006/0053159 A1
(43) Pub. Date: Mar. 9, 2006

(54) Exploiting metadata for performing structure-oriented operations on content-specific data representations

(75) Inventors: Yariv Aridor, Zichron Ya'akov (IL); Yoav Gsl, Haifa (IL); Zvi Har'el, Haifa (IL); Be'ny Rochwerger, Zichron Ya'akov (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/935,509

(22) Filed: Sep. 7, 2004

(51) Int. Cl. G06F 17/00

(52) U.S. Cl. 707/103 R

(57) ABSTRACT

A system for exploiting metadata for performing structure-oriented operations on content-specific data representations, the system including means for deserializing serialized data into a content-specific data representation for use with a programming language, where the means is operative to create metadata that includes any information not found in the deserialized data that is needed to reconstruct the serialized data, and an engine for performing structure-oriented operations on the content-specific data representation, where the engine is operative to employ a priori knowledge regarding the metadata to perform the operations.

### FIELD OF THE INVENTION

The present invention relates to working with data in general, and in particular to performing structure-oriented operations on content-specific data representations.

### BACKGROUND OF THE INVENTION

The Extensible Markup Language (XML) is the de facto standard for platform- and language-independent representation of structured data. In one commonly used approach for processing XML documents using a programming language, a structure-oriented programming interface is employed, such as the Simple API for XML (SAX) or the Document Object Model (DOM). These interfaces, and the underlying implementations specific to different programming languages, provide a generic interface to XML that is driven by structure instead of content, i.e., where programmers deal with generic nodes in a tree and their relationships. The ability to process structured data using generic interfaces has lead to the emergence of powerful structure-oriented tools, such as XSL engines (e.g., XPath, XSLT, XQuery), which can manipulate data without requiring prior knowledge of what is represented by the data. However, the use of generic interfaces can be cumbersome and requires that programmers learn new interfaces and programming paradigms.

In an alternative approach for working with XML data, XML binding tools are employed, such as JAXB, EMF, and WSDL2JAVA, which use a priori knowledge about document content, such as by employing XML schema, to deserialize data from XML format into the the content-specific data structures of the specific programming language for which the binding tool is designed. This approach provides programmers with a familiar interface for working directly with XML data. For example, whereas a structure-oriented approach might employ a statement such as document.getElement(“ShipTo”), a content-specific approach might instead use a statement such as purchaseOrder.getShipTo( ) to achieve the same result. In order to be able to serialize data back to XML format after it has been deserialized to a content-specific data structure, XML binding tools must maintain XML-specific information, such as mappings between a native object's data members and XML elements or attributes, that have no place or function in the native format. This metadata is essential to ensure the integrity of the XML source after deserialization and reserialization.

The main disadvantage of using binding tools and the content-specific data representations generated by them, is that in order to use generic structure-oriented tools, the data must be serialized to the generic format which these tools are able to process. Frequent translation between the different representations of the data may result in severe performance degradation.

### SUMMARY OF THE INVENTION

The present invention discloses a system and method for exploiting metadata for performing generic structure-oriented operations on content-specific data representations, such as for performing XSL transformations on deserialized XML data.

In one aspect of the present invention a system is provided for exploiting metadata for performing structure-oriented operations on content-specific data representations, the system including means for deserializing serialized data into a content-specific data representation for use with a programming language, where the means is operative to create metadata that includes any information not found in the deserialized data that is needed to reconstruct the serialized data, and an engine for performing structure-oriented operations on the content-specific data representation, where the engine is operative to employ a priori knowledge regarding the metadata to perform the operations.

In another aspect of the present invention the data is XML data and the means for deserializing is an XML binding tool.

In another aspect of the present invention the means for deserializing is operative to deserialize the data into at least one data structure for use with the programming language.

In another aspect of the present invention the metadata includes a mapping between a data member of the data structure and an XML element or attribute.

In another aspect of the present invention the metadata includes information relating to a constraint or a relationship described in association with the serialized data that is not mapped to the data structure.

In another aspect of the present invention the metadata is expressed as a class for each element described in an XML document, including its member variables and access methods.

In another aspect of the present invention the metadata is expressed as a table that holds information regarding the nature of a class member.

In another aspect of the present invention the class member information includes whether the member is mapped to an XML element or an XML attribute.

In another aspect of the present invention the class member information includes whether the member is settable.

In another aspect of the present invention the class member information includes a size constraint.

In another aspect of the present invention the table resides in a type-specific class.

In another aspect of the present invention the table resides in a designated class.

In another aspect of the present invention the metadata is expressed as a helper class that supports serialization between the deserialized data and the serialized data.

In another aspect of the present invention the metadata is expressed as a helper class that supports deserialization between the serialized data and the deserialized data.

In another aspect of the present invention the engine is an XSL engine operative to perform XSL transformations on the deserialized data.

In another aspect of the present invention a method is provided for exploiting metadata for performing structure-oriented operations on content-specific data representations, the method including deserializing serialized data into a content-specific data representation for use with a programming language, creating metadata that includes any information not found in the deserialized data that is needed to reconstruct the serialized data, and performing structure-oriented operations on the content-specific data representation, where the engine is operative to employ a priori knowledge regarding the metadata to perform the operations.

In another aspect of the present invention the deserializing step includes deserializing XML data.

In another aspect of the present invention the deserializing step includes deserializing the data into at least one data structure for use with the programming language.

In another aspect of the present invention the creating step includes creating a mapping between a data member of the data structure and an XML element or attribute.

In another aspect of the present invention the creating step includes creating information relating to a constraint or a relationship described in association with the serialized data that is not mapped to the data structure.

In another aspect of the present invention the creating step includes expressing the metadata as a class for each element described in an XML document, including its member variables and access methods.

In another aspect of the present invention the creating step includes expressing the metadata as a table that holds information regarding the nature of a class member.

In another aspect of the present invention the creating step includes expressing the metadata as a helper class that supports serialization between the deserialized data and the serialized data.

In another aspect of the present invention the creating step includes expressing the metadata as a helper class that supports deserialization between the serialized data and the deserialized data.

In another aspect of the present invention the performing step includes performing an XSL transformation on the deserialized data.

In another aspect of the present invention a method is provided for performing XSL Transformations on deserialized XML data, the method including parsing an XSL expression to form an expression tree corresponding thereto, selecting an execute method corresponding to a node of the tree to evaluate an object generated by an XML binding tool, and verifying a characteristic of the node against metadata generated by the XML binding tool prior to executing the method.

In another aspect of the present invention a computer program is provided embodied on a computer-readable medium, the computer program including a first code segment operative to deserialize serialized data into a content-specific data representation for use with a programming language and create metadata that includes any information not found in the deserialized data that is needed to reconstruct the serialized data, and a second code segment operative to perform structure-oriented operations on the content-specific data representation, employing a priori knowledge regarding the metadata to perform the operations.

It is appreciated throughout the specification and claims that generic structure-oriented data may alternatively be referred to as serialized data, while content-specific data representation generated by binding tools may alternatively be referred to as deserialized data.

### BRIEF DESCRIPTION OF THE DRAWINGS

The present invention will be understood and appreciated more fully from the following detailed description taken in conjunction with the appended drawings in which:

FIG. 1 is a simplified block-flow diagram of a system supporting XSL Transformations on deserialized XML data, constructed and operative in accordance with a preferred embodiment of the present invention;

FIGS. 2A and 2B are simplified flowchart illustrations of exemplary methods of operation of the system of FIG. 1, operative in accordance with a preferred embodiment of the present invention;

FIGS. 3A-3E are simplified code snippets of XML binding tool input and output, useful in understanding the present invention;

FIG. 4 is a simplified flowchart illustration of a method for performing XSL Transformations on deserialized XML data, operative in accordance with a preferred embodiment of the present invention; and

FIG. 5 is a simplified diagram of an expression tree, useful in understanding the present invention.

### DETAILED DESCRIPTION OF PREFERRED EMBODIMENTS

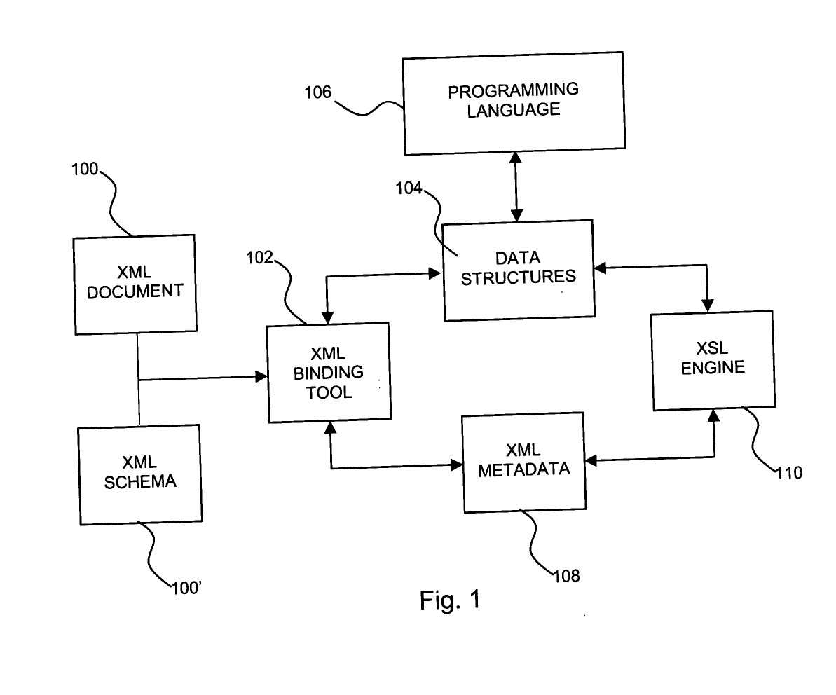

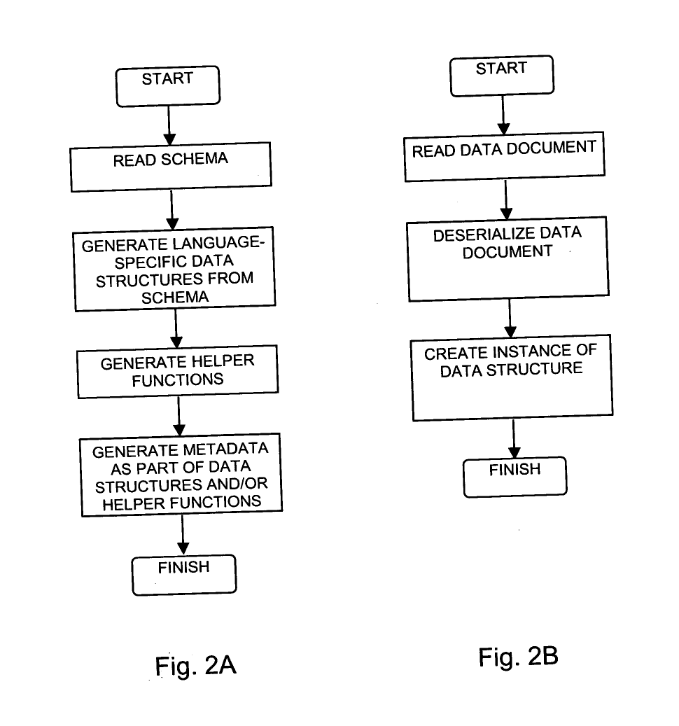

Reference is now made to FIG. 1, which is a simplified block-flow diagram of a system supporting XSL Transformations on deserialized XML data, constructed and operative in accordance with a preferred embodiment of the present invention, and FIGS. 2A and 2B, which are simplified flowchart illustrations of exemplary methods of operation of the system of FIG. 1, operative in accordance with a preferred embodiment of the present invention. Although the present invention is described with regard to performing XSL Transformations on deserialized XML documents, it will be understood that the present invention may be applied in other instances as well where structure-oriented operations are to be performed on content-specific data representations. In the system of FIG. 1 and methods of FIGS. 2A and 2B, data, such as in the form of an XML document 100 in conjunction with its XML schema 100′, are prepared for use by both a programming language 106 and an engine 110, such as an XSL engine, as follows. Schema 100′ is read by an XML binding tool 102, such as the Eclipse Modelling Framework (EMF), publicly available from the Eclipse Foundation, which generates one or more data structures 104 adapted for use with programming language 106, such as JAVA, publicly available from Sun Microsystems, Inc., as well as one or more helper functions. Binding tool 102 also creates XML metadata 108 that includes any XML-specific information not found in data structures 104 that is needed to reconstruct XML document 100 during serialization of instances of data structures 104. For example, XML metadata 108 may include a mapping between the different fields in the data structure and XML elements or attributes where programming language 106 makes no distinction between elements or attributes. XML metadata 108 may also include information relating to constraints and relationships described in XML document 100 that are not mapped to instances of data structures 104. XML metadata 108 may be expressed as follows:
A data structure for each complex element described in XML document 100;
Tables that hold additional information regarding the nature of each field in this data structure, such as which fields are mapped to XML elements and which are mapped to XML attributes, which fields are settable, and what are their size constraints;
Helper functions that support serialization/deserialization between XML document 100 and instances of the data structure 104.

Once the data structures 104 and helper functions have been created, data 100 may be deserialized, such as by binding tool 102 or by helper functions or classes generated by binding tool 102, to create instances of data structures 104, which may then be used by programming language 106.

An engine, such as an XSL engine 110, is provided for performing structure-oriented operations on deserialized data, such as XSL transformations on the deserialized XML data in instances of data structures 104, by employing a priori knowledge regarding XML metadata 108, and specifically how XML metadata 108 may be used to map the deserialized XML data in instance of data structures 104 to their XML equivalents, to perform structure-oriented operations, such as is described in greater detail hereinbelow.

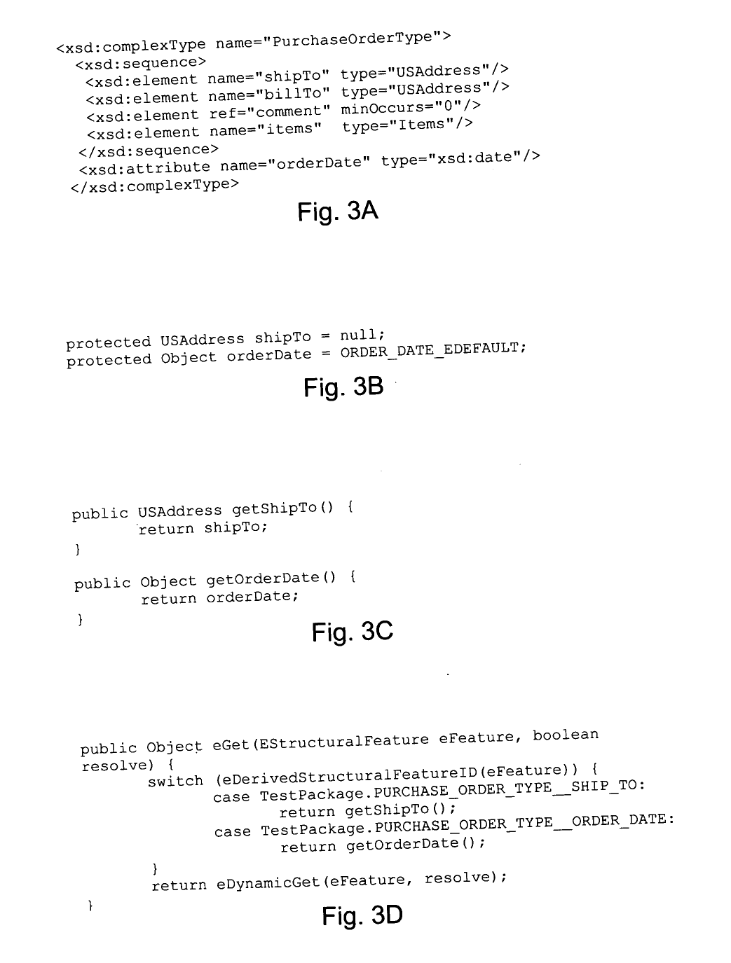

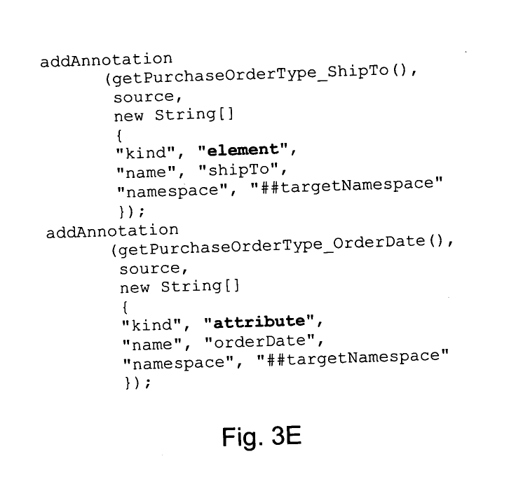

Reference is now made to FIGS. 3A-3E, which are simplified code snippets of XML binding tool input and output, useful in understanding the present invention.

FIG. 3A shows a portion of an XML schema of an exemplary purchase order. As shown in FIG. 3A, “shipTo” and “billTo” are elements of “PurchaseOrderType”, while “orderDate” is an attribute. FIGS. 3B-3E show code snippets generated by EMF based on the XML schema of FIG. 3A, in which FIG. 3B shows member variable declarations, FIG. 3C shows simple getter functions, and FIG. 3D shows reflective getter functions.

FIG. 3E shows an internal representation of metadata, indicating, for example, that “PurchaseOrderType” is a class that corresponds to an XML schema complexType element containing other elements and/or attributes; that “shipTo” is a reference that corresponds to an XML schema element; and that “orderDate” is an XML schema attribute.

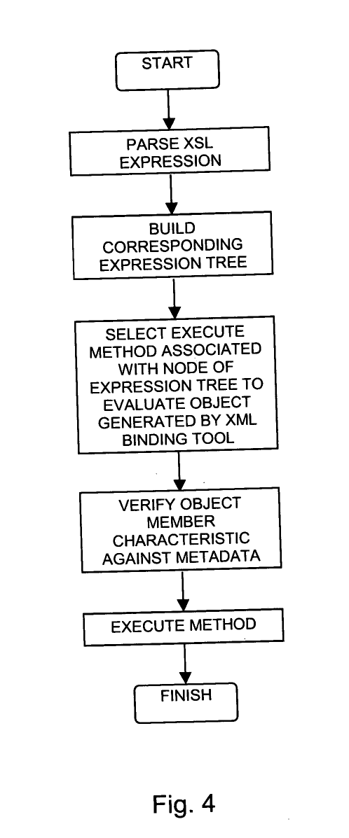

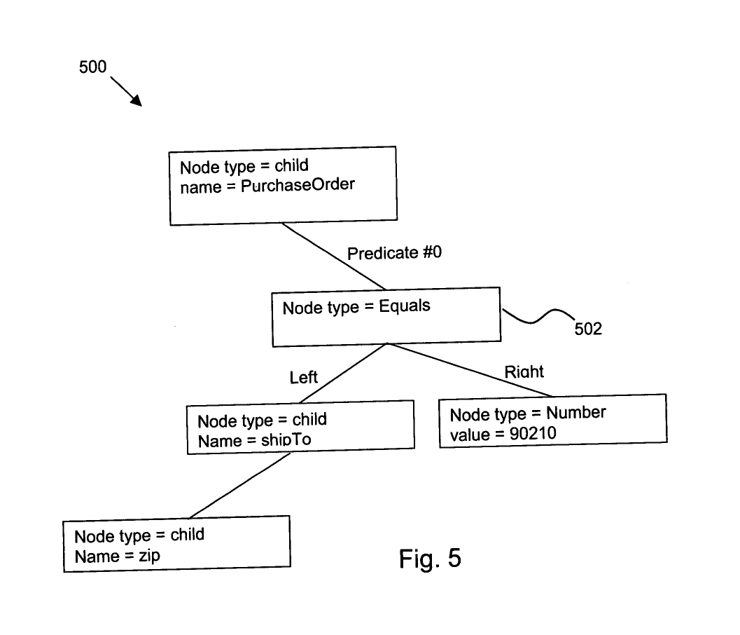

Reference is now made to FIG. 4, which is a simplified flowchart illustration of a method for performing XSL Transformations on deserialized XML data, operative in accordance with a preferred embodiment of the present invention. In the method of FIG. 4, an XSL expression, such as an XPath expression, is parsed and a corresponding expression tree is built in accordance with conventional techniques. For example, the XPath expression “/PurchaseOrder[shipTo/zip=90210]” selects the current purchase order if the zip of its shipTo address' is 90210, and may be parsed to form an expression tree 500 of nodes 502 as shown in FIG. 5. Each node 502 of expression tree 500 typically has an “execute” method which evaluates objects generated by an XML binding tool, such as an “execute(EObject obj)” method for EMF instance objects. For example, given the code snippets of FIGS. 3B-3E, at any node 502 of expression tree 500, the relevant JAVA object may be queried using the relevant reflective getter function of FIG. 3D as determined by the metadata shown in FIG. 3E. Thus, each time expression tree 500 “asks” for an attribute of name ‘X’, the metadata shown in FIG. 3E is consulted to verify that member variable ‘X’ is indeed an attribute and not element.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for exploiting metadata for performing structure-oriented operations on content-specific data representations, the system comprising:
means for deserializing serialized data into a content-specific data representation for use with a programming language, wherein said means is operative to create metadata that includes any information not found in said deserialized data that is needed to reconstruct said serialized data; and
an engine for performing structure-oriented operations on said content-specific data representation, wherein said engine is operative to employ a priori knowledge regarding said metadata to perform said operations.

2. A system according to claim 1 wherein said data is XML data and wherein said means for deserializing is an XML binding tool.

3. A system according to claim 1 wherein said means for deserializing is operative to deserialize said data into at least one data structure for use with said programming language.

4. A system according to claim 1 wherein said metadata includes a mapping between a data member of said data structure and an XML element or attribute.

5. A system according to claim 1 wherein said metadata includes information relating to a constraint or a relationship described in association with said serialized data that is not mapped to said data structure.

6. A system according to claim 1 wherein said metadata is expressed as a class for each element described in an XML document, including its member variables and access methods.

7. A system according to claim 1 wherein said metadata is expressed as a table that holds information regarding the nature of a class member.

8. A system according to claim 7 wherein said class member information includes whether said member is mapped to an XML element or an XML attribute.

9. A system according to claim 7 wherein said class member information includes whether said member is settable.

10. A system according to claim 7 wherein said class member information includes a size constraint.

11. A system according to claim 7 wherein said table resides in a type-specific class.

12. A system according to claim 7 wherein said table resides in a designated class.

13. A system according to claim 1 wherein said metadata is expressed as a helper class that supports serialization between said deserialized data and said serialized data.

14. A system according to claim 1 wherein said metadata is expressed as a helper class that supports deserialization between said serialized data and said deserialized data.

15. A system according to claim 1 wherein said engine is an XSL engine operative to perform XSL transformations on said deserialized data.

16. A method for exploiting metadata for performing structure-oriented operations on content-specific data representations, the method comprising:
deserializing serialized data into a content-specific data representation for use with a programming language;
creating metadata that includes any information not found in said deserialized data that is needed to reconstruct said serialized data; and
performing structure-oriented operations on said content-specific data representation, wherein said engine is operative to employ a priori knowledge regarding said metadata to perform said operations.

17. A method according to claim 16 wherein said deserializing step comprises deserializing XML data.

18. A method according to claim 16 wherein said deserializing step comprises deserializing said data into at least one data structure for use with said programming language.

19. A method according to claim 16 wherein said creating step comprises creating a mapping between a data member of said data structure and an XML element or attribute.

20. A method according to claim 16 wherein said creating step comprises creating information relating to a constraint or a relationship described in association with said serialized data that is not mapped to said data structure.

21. A method according to claim 16 wherein said creating step comprises expressing said metadata as a class for each element described in an XML document, including its member variables and access methods.

22. A method according to claim 16 wherein said creating step comprises expressing said metadata as a table that holds information regarding the nature of a class member.

23. A method according to claim 16 wherein said creating step comprises expressing said metadata as a helper class that supports serialization between said deserialized data and said serialized data.

24. A method according to claim 16 wherein said creating step comprises expressing said metadata as a helper class that supports deserialization between said serialized data and said deserialized data.

25. A method according to claim 16 wherein said performing step comprises performing an XSL transformation on said deserialized data.

26. A method for performing XSL Transformations on deserialized XML data, the method comprising:
parsing an XSL expression to form an expression tree corresponding thereto;
selecting an execute method corresponding to a node of said tree to evaluate an object generated by an XML binding tool; and
verifying a characteristic of said node against metadata generated by said XML binding tool prior to executing said method.

27. A computer program embodied on a computer-readable medium, the computer program comprising:
a first code segment operative to deserialize serialized data into a content-specific data representation for use with a programming language and create metadata that includes any information not found in said deserialized data that is needed to reconstruct said serialized data; and
a second code segment operative to perform structure-oriented operations on said content-specific data representation, employing a priori knowledge regarding said metadata to perform said operations.
